(19) United States
(12) Patent Application Publication
(10) Pub. No.: US 2026/0030248 A1
(43) Pub. Date: Jan. 29, 2026

(54) WORK SUPPORT SYSTEM, WORK SUPPORT METHOD, AND INFORMATION STORAGE MEDIUM

(71) Applicants: Cybozu, Inc., Tokyo (JP); Cybozu Labs, Inc., Tokyo (JP)

(72) Inventors: Yoshinori SANO, Tokyo (JP); Yiping SONG, Narashino-shi (JP); Kazushi TAKAGI, Honjo-shi (JP); Mizue HAYASHI, Sagamihara-shi (JP); Yohei YAMAGUCHI, Tokyo (JP); Shuyo NAKATANI, Tokyo (JP)

(21) Appl. No.: 19/277,411

(22) Filed: Jul. 23, 2025

(30) Foreign Application Priority Data
Jul. 25, 2024 (JP) 2024-120390

(51) Int. Cl. G06F 16/2457

(52) U.S. Cl. CPC G06F 16/24573; G06F 16/24575

(57) ABSTRACT

Provided is a work support system including at least one processor configured to: acquire posted information relating to a post input by a user to a work support system that supports work of the user; acquire, based on the posted information, registered information registered in the work support system; and perform work support by an artificial intelligence (AI) based on the registered information.

### CROSS-REFERENCE TO RELATED APPLICATION

The present disclosure contains subject matter related to that disclosed in Japanese Patent Application JP 2024-120390 filed in the Japan Patent Office on Jul. 25, 2024, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, there have been known work support systems for supporting work of users. For example, in Japanese Patent Application Laid-open No. 2021-157668, there is described a technology which displays a help page relating to a work support function which supports work (for example, sales management work, accounting work, human resources and labor-related work, or core system work) in a company, for example, on a terminal of a user who is using the work support function. The user searches for information required for his or her own work from the help page.

### SUMMARY OF THE INVENTION

However, in the technology of Japanese Patent Application Laid-open No. 2021-157668, the user is required to operate his or her own terminal to open the help page and search for the information required for his or her own work, which is time-consuming for the user. For that reason, the technology of Japanese Patent Application Laid-open No. 2021-157668 has not been able to sufficiently increase convenience of the user.

One object of the present disclosure is to increase convenience of a user.

According to at least one aspect of the present disclosure, there is provided a work support system including at least one processor configured to: acquire posted information relating to a post input by a user to a work support system that supports work of the user; acquire, based on the posted information, registered information registered in the work support system; and perform work support by an artificial intelligence (AI) based on the registered information.

### BRIEF DESCRIPTION OF THE DRAWINGS

FIG. 1 is a diagram for illustrating an example of a hardware configuration of a work support system.

FIG. 2 is a view for illustrating an example of an app screen.

FIG. 3 is a view for illustrating an example of an app screen.

FIG. 4 is a view for illustrating an example of an app screen.

FIG. 5 is a diagram for illustrating an example of functions implemented in the work support system.

FIG. 6 is a table for showing an example of a posted information database.

FIG. 7 is a table for showing an example of a registered information database.

FIG. 8 is a diagram for illustrating an example of a relationship between inputs to an AI and an output from the AI.

FIG. 9 is a flow chart for illustrating an example of processing executed in the work support system.

FIG. 10 is a diagram for illustrating an example of functions implemented in a work support system according to modification examples.

FIG. 11 is a diagram for illustrating an example of relevance information changed in Modification Example 1.

FIG. 12 is a view for illustrating an example of an app screen in Modification Example 7.

FIG. 13 is a view for illustrating an example of an app screen in Modification Example 8.

### DESCRIPTION OF THE EMBODIMENTS

### 1. Hardware Configuration

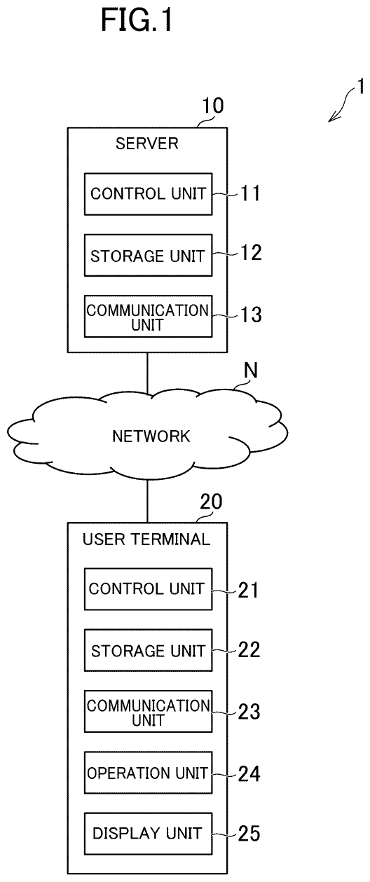

An example of a work support system, a work support method, and a program according to at least one embodiment of the present disclosure is described. FIG. 1 is a diagram for illustrating an example of a hardware configuration of the work support system. For example, a work support system 1 includes a server 10 and a user terminal 20. The server 10 and the user terminal 20 are each connected to a network N such as the Internet or a LAN.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. For example, the user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 is an input device such as a mouse or a touch panel. The display unit 25 is a liquid crystal display or an organic EL display.

Programs stored in the storage units 12 and 22 may be supplied via the network N. A hardware configuration of each of the server 10 and the user terminal 20 is not limited to the example of FIG. 1. For example, at least one of the server 10 or the user terminal 20 may include at least one of a reading unit (for example, a memory card slot) that reads a computer-readable information storage medium or an input/output unit (for example, a USB terminal) for directly connecting to an external device. A program stored in the information storage medium may be supplied to at least one of the server 10 or the user terminal 20 through at least one of the reading unit or the input/output unit.

Moreover, the work support system 1 is only required to include at least one computer. The computers included in the work support system 1 are not limited to the example of FIG. 1. For example, the work support system 1 may include only the server 10. In this case, the user terminal 20 is present outside the work support system 1. The work support system 1 may include only the user terminal 20. In this case, the server 10 is present outside the work support system 1. The work support system 1 may include another computer which is not shown in FIG. 1.

### 2. Overview of Work Support System

In the at least one embodiment, the work support system 1 has various functions that support work of users. For example, the work support system 1 may provide users with groupware of a cloud type or an on-premises type. The work support system 1, which is not classified as groupware, may provide users with a service that supports work. The work support system 1 according to the at least one embodiment includes a communication tool that supports work as one of the above-mentioned functions. The communication tool is a tool for a user to communicate with other users about matters relating to work.

In the at least one embodiment, a comment function of an app, which is a type of database, is described as an example of the communication tool, but the communication tool may be of another type. The communication tool is not limited to the comment function of the app. Examples of the communication tool may include conversation threading and a bulletin board, an online chat, a message app, a social networking service (SNS), a short message service (SMS), and other tools that are not classified as conversation threading.

For example, a user cooperates with other users in an organization such as a company to carry out work. The user communicates with other users in relation to the work through use of the communication tool provided by the work support system 1. For example, when the user logs in to the work support system 1 and selects the app, the user terminal 20 displays an app screen indicating content of a record registered in the app on the display unit 25. In the at least one embodiment, a case in which the app screen is displayed on a browser of the user terminal 20 is taken as an example, but the app screen may be displayed on an application for the work support system 1.

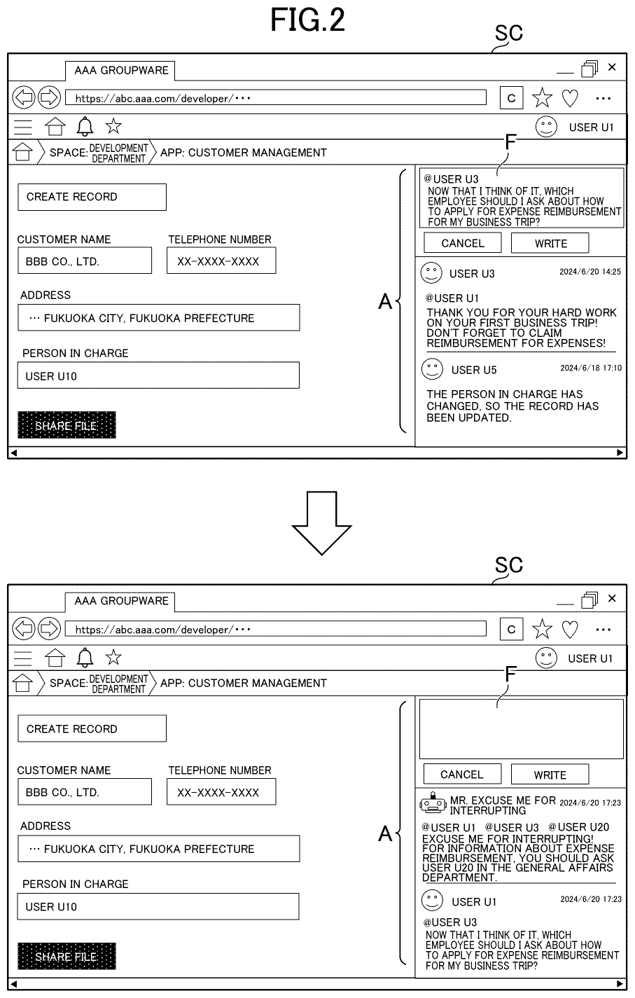

FIG. 2 is a view for illustrating an example of an app screen. In the example of the upper part of FIG. 2, an app screen SC of a customer management app for managing customers of a user is illustrated. For example, the app screen SC includes a display area A showing comments registered in a record of the app. A comment is an example of a post. In the display area A, each of a plurality of comments registered in the record is arranged in reverse chronological order. The user can input a new comment into an input form F. When the user registers a new comment in the record, the new comment is displayed in the display area A.

In the at least one embodiment, when the user registers a comment in the record of the app, an artificial intelligence (AI) presents the user with information for supporting the work of the user. The AI is a program having artificial intelligence that supports work of users. There are various views in terms of definitions of the AI, but the AI in the at least one embodiment may be an AI defined by any one of various publicly-known definitions. The AI may be an AI called a generative AI or a conversational AI. Examples of the AI may include a large language model, a machine learning model not classified as a large language model, a program called a bot, and other programs. There are also various views in terms of definitions of machine learning, but the machine learning in the at least one embodiment may be machine learning defined by any one of various publicly-known definitions. The machine learning may be any one of supervised learning, semi-supervised learning, or unsupervised learning.

In the at least one embodiment, a case in which the large language model corresponds to the AI is taken as an example. Further, a case in which the AI is managed by an external operator different from an administrator of the work support system 1 (for example, a company providing cloud-based groupware) is taken as an example. The work support system 1 uses, via the network N, the AI managed by the external operator. The AI managed by the external operator may be tuned for the work support system 1, but in the at least one embodiment, a case in which the AI is a general-purpose AI that is usable as well by people other than the person using the work support system 1 is taken as an example.

For example, a general-purpose AI can generate a general answer in order to solve a question by the user, but is not able to generate an answer suitable for work support. Tuning the AI for the work support system 1 is also possible, but preparing training data for the tuning is very time-consuming. Thus, in the at least one embodiment, registered information registered in the work support system 1 is input to the AI, to thereby cause the AI to generate an answer suitable for work support.

For example, there may be a case in which an employee directory of an organization to which the user belongs has been registered as registered information in the work support system 1. The employee directory shows the names and affiliations of all the employees, including the user. As illustrated in the upper part of FIG. 2, when posted information such as “Now that I think of it, which employee should I ask about how to apply for expense reimbursement for my business trip?” is acquired, the server 10 acquires the employee directory as registered information suitable for the posted information. As described in detail later, the registered information registered in the work support system 1 is associated with a vector indicating the meaning of the registered information, and the server 10 can acquire registered information corresponding to the posted information of the user.

For example, the server 10 inputs the posted information and the employee directory to the AI, and displays the answer from the AI on the app screen SC. For example, as illustrated in the lower part of FIG. 2, the app screen SC displays generated information such as “For information about expense reimbursement, you should ask user U20 in the general affairs department” generated by the AI (in the example of the lower part of FIG. 2, “Mr. Excuse me for interrupting”). The generated information is information generated by the AI. For example, the generated information may be a character string (text), an image, a table, a diagram, or other information. In the at least one embodiment, even when the user does not explicitly instruct the AI to perform support, the AI generates generated information for supporting the work of the user in response to the post of the user.

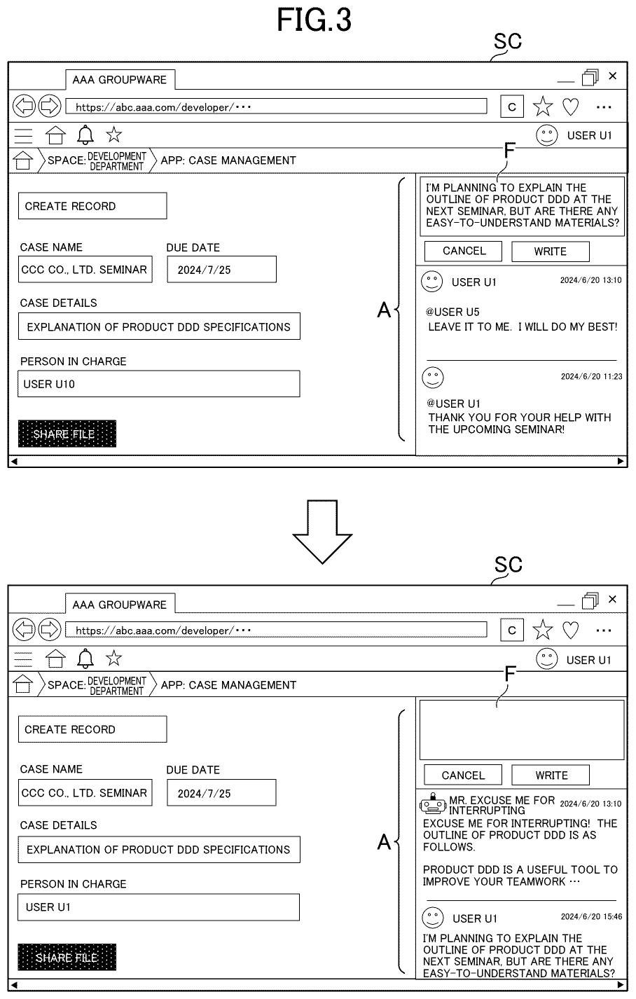

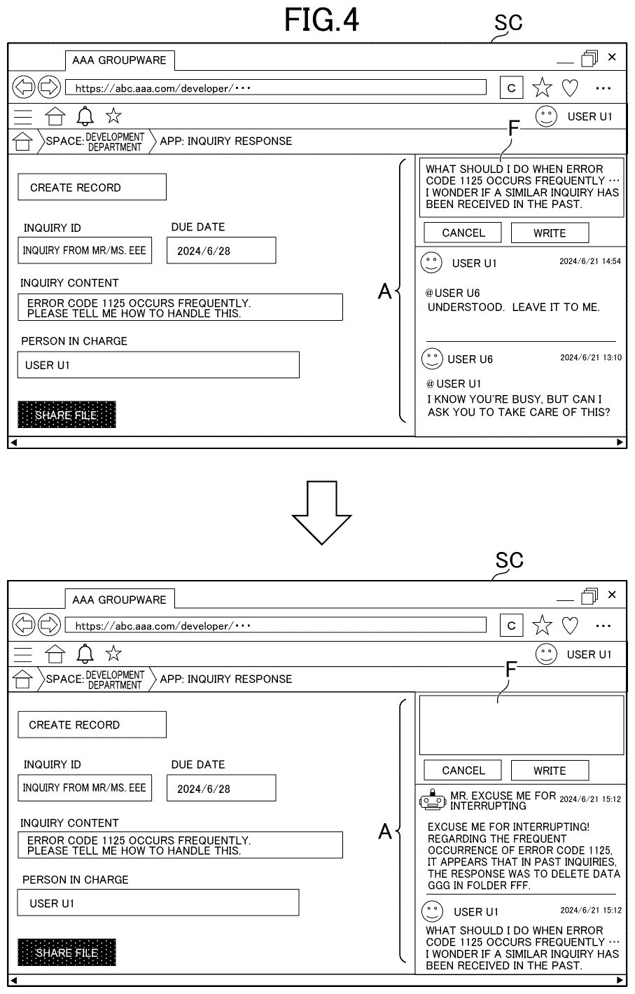

FIG. 3 and FIG. 4 are diagrams for illustrating examples of app screens SC. In the example of the upper part of FIG. 3, an app screen SC of a case management app for managing cases of the user is illustrated. For example, when posted information such as “I'm planning to explain the outline of product DDD at the next seminar, but are there any easy-to-understand materials?” is registered in the case management app, the server 10 acquires the catalog of the product DDD as registered information suitable for the posted information. The server 10 inputs the posted information and the registered information to the AI, and displays the answer from the AI on the app screen SC. As illustrated in the lower part of FIG. 3, the app screen SC displays generated information such as “Product DDD is a useful tool to improve your teamwork . . . ” summarized by the AI from the catalog of the product DDD.

In the example of the upper part of FIG. 4, an app screen SC of an inquiry response app for managing responses to inquiries is illustrated. For example, when posted information such as “What should I do when error code 1125 occurs frequently . . . I wonder if a similar inquiry has been received in the past” is registered in the inquiry response app, the server 10 acquires an inquiry example that is a compilation of past inquiry examples as registered information suitable for the posted information. The server 10 inputs the posted information and the registered information to the AI, and displays the answer from the AI on the app screen SC. As illustrated in the lower part of FIG. 4, the app screen SC displays generated information such as “Regarding the frequent occurrence of error code 1125, it appears that in past inquiries, the response was to delete data GGG in folder FFF,” which is a predetermined response method extracted by the AI from the inquiry examples.

As described above, the work support system 1 acquires registered information to be input to the AI based on posted information indicating the post input by the user. The work support system 1 supports the work of the user by inputting the posted information and the registered information to the AI and presenting the output information output from the AI to the user. In this way, the AI generates, instead of a general answer, generated information specific to the work support system 1, and the user can obtain generated information suitable for his or her own work, and hence the work support system 1 can increase convenience of the user. Details of the work support system 1 are described below.

### 3. Functions Implemented in Work Support System

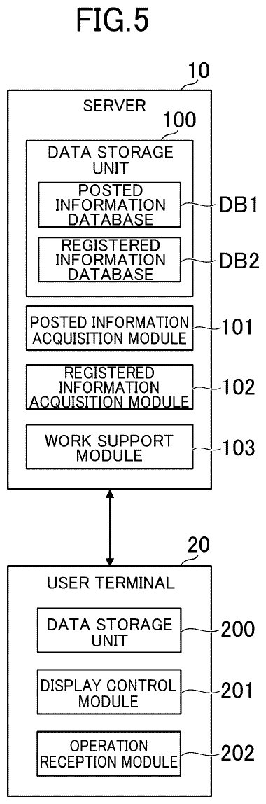

FIG. 5 is a diagram for illustrating an example of functions implemented in the work support system 1.

### 3-1. Functions Implemented in Server

For example, the server 10 includes a data storage unit 100, a posted information acquisition module 101, a registered information acquisition module 102, and a work support module 103. The data storage unit 100 is implemented by the storage unit 12. Each of the posted information acquisition module 101, the registered information acquisition module 102, and the work support module 103 is implemented by the control unit 11.

### [Data Storage Unit]

The data storage unit 100 stores data for supporting work. For example, the data storage unit 100 stores a posted information database DB1 and a registered information database DB2.

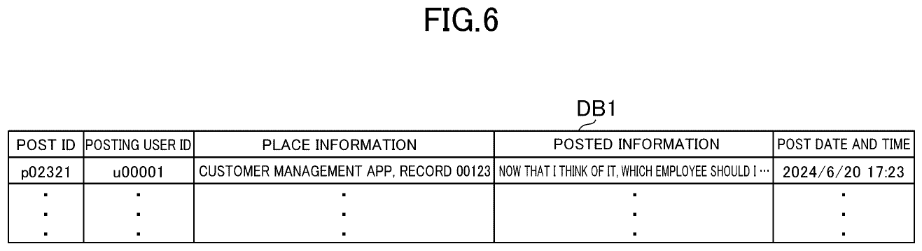

FIG. 6 is a table for showing an example of the posted information database DB1. The posted information database DB1 is a database in which a plurality of pieces of posted information are stored. For example, the posted information database DB1 stores a post ID, a posting user ID, place information, posted information, and a post date and time. Any information may be stored in the posted information database DB1. The information stored in the posted information database DB1 is not limited to the example of FIG. 6. For example, the posted information database DB1 may store the number of likes, the number of views, the number of replies, or other information on the post.

The post ID is an ID that can identify the post in the work support system 1. The posting user ID is the user ID of the user who has input the post. The user ID is an ID that can identify the user in the work support system 1. When the generated information generated by the AI corresponds to posted information, an ID that can identify the AI may be used as the posting user ID. The place information is information that can identify the place from which the post is made. For example, the place information may be the ID of the app to which the post is made, the ID of a record, the ID of a thread, the ID of a schedule managed by a schedule management tool having a comment function, the ID of an email managed by an email management tool having a comment function, or another ID.

The posted information is information relating to the post input by the user. In the at least one embodiment, the posted information indicates a character string (text) input in natural language. The posted information may indicate information other than a character string. For example, the posted information may indicate symbols not classified as characters, an emoji, an image, a file, information on a mention, information on a reaction, or other information. The post date and time is the date and time at which the post is made. The post indicated by the posted information may also be called a comment or a message.

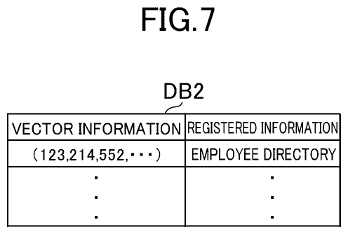

FIG. 7 is a table for showing an example of the registered information database DB2. The registered information database DB2 is a database in which a plurality of pieces of registered information are stored. For example, the registered information database DB2 stores vector information and registered information. The information stored in the registered information database DB2 is not limited to the example of FIG. 7. For example, when the actual data of the registered information is stored in a place other than the registered information database DB2, a link to the registered information may be stored in the registered information database DB2. In addition, for example, the registered information database DB2 may store meta information, which is described later. The registered information database DB2 may be prepared by the user or by the administrator of the work support system 1.

The vector information is information indicating the meaning of the registered information in a vector format. The vector information may also be called an embedded representation. The vector indicated by the vector information is used in order to allow a computer to recognize the meaning of natural language. The vector information may have any number of dimensions, and may be in various formats used in the field of natural language. The vector information is used as an index to be used in searching the registered information. The index of the registered information may be information other than vector information. For example, the index of the registered information may be information in which the meaning of a word is expressed in a format other than the vector format (for example, an array, a matrix, a single numerical value, or a combination of a plurality of numerical values), a keyword, a sentence, or other information.

The registered information is information registered in the work support system 1. The registered information can also be said to be information relating to the work of the user. The posted information is also a type of registered information. The registered information may be information other than posted information. For example, the registered information may be a record registered in an app (for example, a specific value of a field), a file uploaded to the work support system 1, information (for example, information indicating the specific content of a schedule, information indicating the specific content of a task, or information indicating the specific content of a shared email) registered in a tool other than a communication tool (for example, a schedule management tool, a task management tool, or a shared email management tool), or other information.

For example, the vector information associated with the registered information may be prepared by an administrator of the work support system 1, or the server 10 may acquire the vector information by creating a summary of the registered information and vectorizing the meaning of the summary. The server 10 acquires vector information indicating the meaning of the registered information for each piece of registered information, and stores the vector information and the registered information in the registered information database DB2. Similarly, when information other than the vector information is used as the index of the registered information, the server 10 may store an index prepared by an administrator in the registered information database DB2 in association with the registered information, or may execute morphological analysis, for example, on the registered information to extract keywords, and store the extracted keywords as an index in the registered information database DB2 in association with the registered information.

The data stored in the data storage unit 100 is not limited to the example described above. The data storage unit 100 may store any data for supporting work. For example, the data storage unit 100 may store a default prompt to be input to the AI. When the AI is not managed by an external system but is managed by the server 10, the data storage unit 100 may store the actual data of the AI. The AI includes a program which performs, for example, calculations of the embedded representation and parameters referenced by the program. The data storage unit 100 may store data (for example, HTML data) for displaying the app screen SC. The data storage unit 100 may store the actual data of the content of the record of the app.

### [Posted Information Acquisition Module]

The posted information acquisition module 101 acquires posted information relating to the post input by the user in the work support system 1 supporting the work of the user. For example, when the user inputs a new post by using a communication tool such as a comment function of an app, the user terminal 20 transmits posted information indicating the new post to the server 10. The posted information acquisition module 101 acquires the posted information from the user terminal 20. The posted information acquisition module 101 stores the posted information in the posted information database DB1. The posted information acquisition module 101 can acquire any posted information at any time from the posted information database DB1. For example, when work support by the AI is performed after the posted information is stored in the posted information database DB1, the posted information acquisition module 101 may acquire, from the posted information database DB1, the posted information of the user who has made the post which is the subject of the work support.

For example, the posted information acquisition module 101 issues a post ID for a new post so that the post ID of the new post is not the same as the other post IDs. The posted information acquisition module 101 stores the posting user ID, which is the user ID of the user who has made the post, place information such as the app ID of the app in which the post is made, the posted information, and the post date and time in the posted information database DB1 in association with the new post ID. The user terminal 20 transmits the posting user ID and the place information together with the posted information to the server 10. The posted information acquisition module 101 acquires the posting user ID and the place information from the user terminal 20. The posted information acquisition module 101 acquires the date and time at which the posted information is acquired as the post date and time.

### [Registered Information Acquisition Module]

The registered information acquisition module 102 acquires registered information registered in the work support system 1 based on the posted information. In the at least one embodiment, a case in which the registered information acquisition module 102 acquires the registered information from the registered information database DB2 is taken as an example, but the registered information acquisition module 102 may acquire the registered information based on another method. For example, the registered information acquisition module 102 may acquire information that is not stored in the registered information database DB2 as the registered information. For example, the registered information acquisition module 102 may acquire graphed information as the registered information, or may retrieve the registered information by combining a plurality of search methods. For example, the registered information acquisition module 102 may search the registered information database DB2 by using the posted information as a query based on a publicly-known search engine (for example, a search engine provided by a company operating a search portal site). The search engine outputs registered information corresponding to the posted information, which is the query, based on the index stored in the registered: information database DB2. The registered information acquisition module 102 acquires the registered information retrieved in the search by the search engine. The search engine outputs registered information having the index corresponding to the query.

In the at least one embodiment, vector information is used as the index, and hence the registered information acquisition module 102 acquires registered information associated with vector information having a meaning similar to that of the posted information from the registered information database DB2. For example, the registered information acquisition module 102 inputs the posted information to a publicly-known program (for example, a large language model or an encoder used in natural language processing) which calculates vector information from the input character string, and acquires the vector information on the posted information calculated by the program. For example, the registered information acquisition module 102 may acquire a plurality of pieces of registered information by using a method similar to the information search method in retrieval-augmented generation (RAG), which is a mechanism that searches for information and generates an answer by using the search result.

For example, the registered information acquisition module 102 acquires the registered information associated with the vector information closest to the vector information on the posted information from the registered information database DB2. As used herein, “closest vector information” refers to the information having the closest distance in the vector space. The registered information acquisition module 102 may acquire the registered information associated with the vector information that is the second (or lower, for example) closest to the vector information on the posted information. For example, the registered information acquisition module 102 may acquire up to a predetermined number of pieces of registered information in order of closeness to the vector information on the posted information. The registered information acquisition module 102 may acquire the registered information associated with the vector information that is within a predetermined distance from the vector information on the posted information.

For example, as illustrated in FIG. 2, there may be a case in which posted information such as “Now that I think of it, which employee should I ask about how to apply for expense reimbursement for my business trip?” is acquired. In this case, the registered information acquisition module 102 converts the posted information into vector information, and identifies the vector information that is closest to the vector information on the posted information from the registered information database DB2. The employee directory stored in the registered information database DB2 is registered information relating to employees, and hence it is assumed that the vector information on the employee directory is closest to the vector information on the posted information. In this case, the registered information acquisition module 102 acquires the employee directory from the registered information database DB2 as the registered information.

For example, as illustrated in FIG. 3, there may be a case in which posted information such as “I'm planning to explain the outline of product DDD at the next seminar, but are there any easy-to-understand materials?” is acquired. In this case, the registered information acquisition module 102 converts the posted information into vector information, and identifies the vector information that is closest to the vector information on the posted information from the registered information database DB2. The catalog of the product DDD stored in the registered information database DB2 is information relating to the product DDD, and hence it is assumed that the vector information on the catalog of the product DDD is closest to the vector information on the posted information. In this case, the registered information acquisition module 102 acquires the catalog as the registered information from the registered information database DB2.

For example, as illustrated in FIG. 4, there may be a case in which posted information such as “What should I do when error code 1125 occurs frequently . . . I wonder if a similar inquiry has been received in the past” is acquired. In this case, the registered information acquisition module 102 converts the posted information into vector information, and identifies the vector information that is closest to the vector information on the posted information from the registered information database DB2. The inquiry examples stored in the registered information database DB2 are information relating to examples of inquiries received in the past, and hence it is assumed that the vector information on the inquiry examples is closest to the vector information on the posted information. In this case, the registered information acquisition module 102 acquires the inquiry examples from the registered information database DB2 as the registered information.

In addition, when an index other than vector information is associated with the registered information, the registered information acquisition module 102 may execute, based on a search engine, a search by referring to the index by using the posted information as a query, and acquire the registered information retrieved in the search. The registered information acquisition module 102 may acquire the registered information based on another program (for example, AI that has been trained to acquire registered information) instead of a search engine.

### [Work Support Module]

The work support module 103 performs the work support by the AI based on the registered information. In the at least one embodiment, a case in which a large language model managed by an external operator corresponds to the AI is taken as an example, and hence the work support module 103 transmits the posted information and the registered information to an external system, which is the system of the external operator. When the external system receives the posted information and the registered information transmitted by the work support module 103, the external system inputs the registered information to the AI. The work support module 103 acquires output information of the AI from the external system, and presents the output information to the user, to thereby perform work support to the user.

As used herein, “presents the output information” means transmitting the output information to the user terminal 20. In the examples of FIG. 2 to FIG. 4, the work support module 103 presents the output information to the user by displaying the output information on the app screen SC. The work support module 103 may display the output information on a screen other than the app screen SC (for example, a thread screen, a schedule screen, or an email screen). For example, the work support module 103 may present the output information to the user by using another medium, for example, email, instead of the screen of the work support system 1.

In the at least one embodiment, a case in which the AI is a generative pre-trained transformer (GPT) is taken as an example, but the AI may be another type of publicly-known AI. The AI is not limited to GPT. For example, the AI may be a transformer-based model other than GPT (for example, bidirectional encoder representations from transformers: BERT), a large language model other than a transformer-based model, a machine learning model not classified as a large language model (for example, a neural network), or a program that does not use machine learning methods.

The AI calculates an embedded representation of the information (for example, registered information) input to the AI based on parameters adjusted by pre-training. The embedded representation is information which indicates the meaning of the input information. The embedded representation may be in any form. For example, the embedded representation may be a vector, an array, a matrix, a single numerical value, or a combination of a plurality of numerical values. The AI generates and outputs generated information corresponding to the embedded representation. The AI may divide the registered information into units called tokens, and calculate an embedded representation for each token. The AI may output generated information corresponding to the sequence of the embedded representations of the tokens, or may output generated information after predicting the next sentence as required.

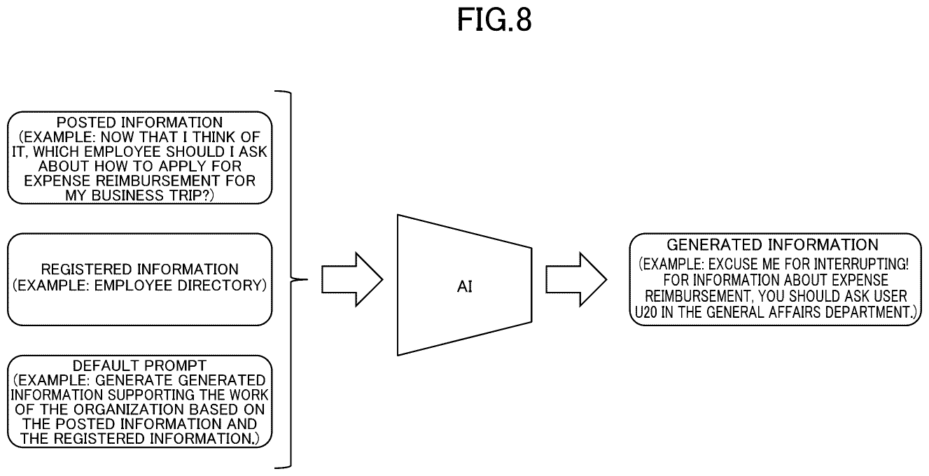

FIG. 8 is a diagram for illustrating an example of a relationship between inputs to the AI and an output from the AI. In the example of FIG. 8, a case in which the work support module 103 performs work support to the user by inputting the posted information and the registered information to the AI, and presenting the generated information generated by the AI to the user is taken as an example. The work support module 103 may input only the registered information, and not input the posted information, to the AI. In the at least one embodiment, the AI is managed by an external system, and hence the work support module 103 inputs the registered information and the like to the AI by transmitting the registered information and the like to be input to the AI to the external system.

For example, the work support module 103 may input a default prompt to the AI. In the case of a general-purpose AI such as GPT, when the task to be executed by the AI is not clearly indicated, the accuracy of the generated information generated by the AI may not be sufficiently increased. Thus, the work support module 103 may input a default prompt including natural language indicating that generated information which supports the work of the user is to be output, such as “Generate generated information supporting the work of the organization based on the posted information and the registered information” to the AI. The default prompt may include natural language indicating what information is to be input to the AI. The default prompt may include a tag for embedding the posted information and the registered information into a natural language sentence.

In FIG. 8, there is illustrated a relationship between inputs and an output when posted information like that of FIG. 2 is acquired. For example, there may be a case in which posted information such as “Now that I think of it, which employee should I ask about how to apply for expense reimbursement for my business trip?” is acquired, and the employee directory has been acquired as the registered information. In this case, the work support module 103 inputs the posted information and the employee directory, which is an example of registered information, to the AI. In the example of FIG. 8, the work support module 103 also inputs a default prompt to the AI. The AI calculates an embedded representation of those inputs, and outputs generated information such as “For information about expense reimbursement, you should ask user U20 in the general affairs department” as generated information corresponding to the embedded representation. The work support module 103 acquires the generated information output by the AI, and displays the generated information in the display area A of the app screen SC, to thereby perform the work support by the AI.

For example, as illustrated in FIG. 3, there may be a case in which posted information such as “I'm planning to explain the outline of product DDD at the next seminar, but are there any easy-to-understand materials?” is acquired, and the catalog of the product DDD is acquired as the registered information. In this case, the work support module 103 inputs the posted information and the catalog of the product DDD, which is an example of registered information, to the AI. The AI calculates an embedded representation of those inputs, and outputs generated information such as “Product DDD is a useful tool to improve your teamwork . . . ” as the generated information corresponding to the embedded representation. The work support module 103 acquires the generated information output by the AI, and displays the generated information in the display area A of the app screen SC, to thereby perform the work support by the AI.

For example, there may be a case in which, like in FIG. 4, posted information such as “What should I do when error code 1125 occurs frequently . . . I wonder if a similar inquiry has been received in the past” is acquired, and examples of inquiries are acquired as the registered information. In this case, the work support module 103 inputs the posted information and the inquiry examples, which are an example of registered information, to the AI. The AI calculates an embedded representation of those inputs, and outputs, as generated information corresponding to the embedded representation, generated information such as “Regarding the frequent occurrence of error code 1125, it appears that in past inquiries, the response was to delete data GGG in folder FFF.” The work support module 103 acquires the generated information output by the AI, and displays the generated information in the display area A of the app screen SC, to thereby perform the work support by the AI.

The work support module 103 may present the generated information generated by the AI to the user as is, or may add a standard phrase such as “Excuse me for interrupting!” to the generated information and then present the generated information with the added standard phrase to the user, like in FIG. 2 to FIG. 4. Further, the work support module 103 may perform the work support by the AI each time the user makes a post, but there may also be cases in which a post that does not require work support in particular is input. Thus, the work support module 103 may determine, based on the posted information, whether or not to perform the work support by the AI.

For example, the work support module 103 may read the syntax of the posted information, and when the post contains a question, determine to perform the work support by the AI, and when the post does not contain a question, determine not to perform the work support by the AI. The work support module 103 may determine whether or not to perform the work support by the AI by using another AI for determining whether or not to perform the work support by the AI. The work support module 103 may perform the work support by the AI only to users who have turned on a work support function by the AI. The work support module 103 may perform the work support by the AI only when a post is made to a specific place, for example, a specific app or a specific thread. The work support module 103 may perform the work support by the AI only when a user explicitly instructs the work support by the AI.

### 3-2. Functions Implemented in User Terminal

For example, the user terminal 20 includes a data storage unit 200, a display control module 201, and an operation reception module 202. The data storage unit 200 is implemented by the storage unit 22. Each of the display control module 201 and the operation reception module 202 is implemented by the control unit 21.

### [Data Storage Unit]

The data storage unit 200 stores data for the work support. For example, the data storage unit 200 stores a browser for displaying various screens of the work support system 1. For example, the data storage unit 200 stores an application dedicated to the work support system 1.

### [Display Control Module]

The display control module 201 displays various screens in the work support system 1 on the display unit 25. For example, the display control module 201 displays, on the display unit 25, various screens such as the app screen SC based on data received from the server 10.

### [Operation Reception Module]

The operation reception module 202 receives various operations in the work support system 1. For example, the operation reception module 202 receives operations on various screens such as the app screen SC. Data indicating the operation content received by the operation reception module 202 is transmitted to the server 10. When the user inputs a post, the operation reception module 202 transmits, to the server 10, posted information indicating the post input by the user.

### 4. Processing Executed in Work Support System

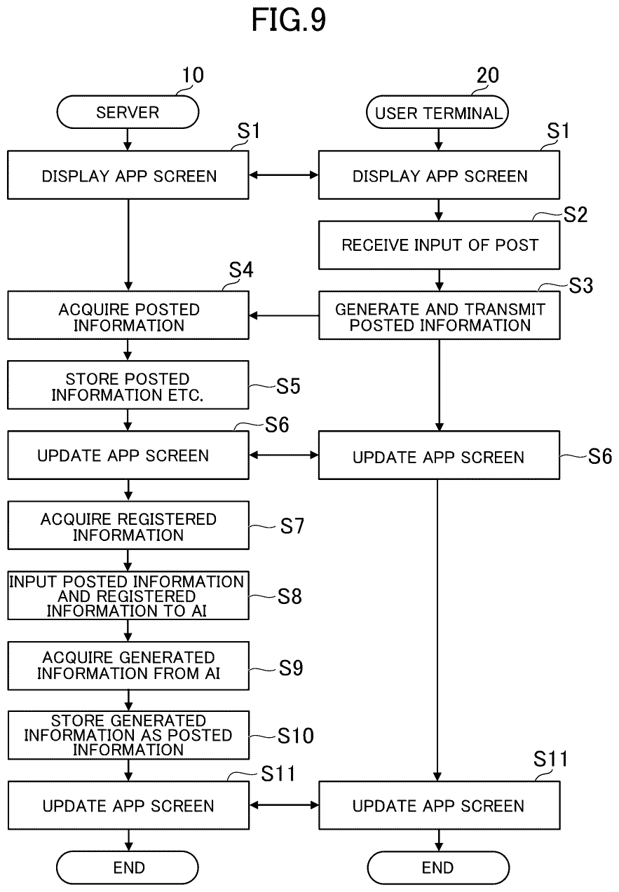

FIG. 9 is a flowchart for illustrating an example of processing executed in the work support system 1. The processing of FIG. 9 is executed by the control units 11 and 21 executing the programs stored in the storage units 12 and 22, respectively. The processing of FIG. 9 is executed when the user logs in to the work support system 1 and then uses the comment function of the app to input a post.

As illustrated in FIG. 9, when a user logs in to the work support system 1 and selects a freely-selected record of a freely-selected app, the user terminal 20 executes, between the user terminal 20 and the server 10, processing for displaying an app screen SC showing the content of the record (Step S1). The user terminal 20 receives input of a post into the input form F of the app screen SC (Step S2). When the user performs an operation to complete input of the post, the user terminal 20 generates posted information and transmits the generated posted information to the server 10 (Step S3). The server 10 acquires the posted information from the user terminal 20 (Step S4). The server 10 issues a post ID, and stores the posted information and the like in the posted information database DB1 (Step S5). The server 10 executes, between the server 10 and the user terminal 20, processing for updating the app screen SC (Step S6). As a result of the processing step of Step S6, the post input by the user is reflected in the display area A of the app screen SC.

The server 10 acquires registered information from the registered information database DB2 based on the posted information (Step S7). The server 10 inputs the posted information acquired in Step S4 and the registered information acquired in Step S7 to the AI by transmitting those pieces of information to an external system (Step S8). In Step S8, the server 10 may also transmit a default prompt to the external system. The server 10 acquires generated information corresponding to the posted information and the registered information from the AI of the external system (Step S9). The server 10 stores the generated information of the AI in the posted information database DB1 as posted information by the AI (Step S10). The server 10 executes, between the server 10 and the user terminal 20, processing for updating the app screen SC (Step S11), and the process ends. As a result of the processing step of Step S11, the output information from the AI is reflected as a new comment in the display area A of the app screen SC.

### 5. Summary of at Least One Embodiment

The work support system 1 according to the at least one embodiment acquires posted information relating to a post input by a user to the work support system 1. The work support system 1 acquires registered from information the registered information database DB2 based on the posted information. The work support system 1 performs the work support by the AI based on the registered information. As a result, the AI can generate, instead of a general answer, generated information specific to the work support system 1 by using registered information specific to the work support system 1. The user can obtain generated information suitable for his or her own work, and hence the work support system 1 can increase the convenience of the user.

Further, the work support system 1 performs work support to the user by inputting posted information and registered information to the AI, and presenting the generated information generated by the AI to the user. As a result, the work support system 1 can cause the AI to generate not only registered information, but also generated information corresponding to the posted information, and hence generated information suited to the specific content of the post of the user can be presented to the user. As a result, the user can obtain generated information suited to the content of the work that the user is currently working on, and hence the work support system 1 can increase the convenience of the user.

### 6. Modification Examples

The present disclosure is not limited to the at least one embodiment described above. The present disclosure can be modified as required without departing from the purport of the present disclosure.

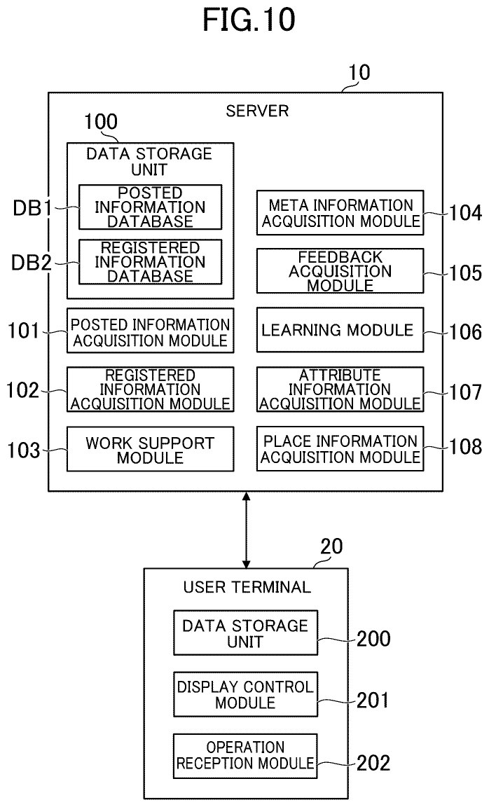

FIG. 10 is a diagram for illustrating an example of functions implemented in the work support system 1 according to modification examples. As illustrated in FIG. 10, in the modification examples described below, a meta information acquisition module 104, a feedback acquisition module 105, a learning module 106, an attribute information acquisition module 107, and a place information acquisition module 108 are implemented. Each of the meta information acquisition module 104, the feedback acquisition module 105, the learning module 106, the attribute information acquisition module 107, and the place information acquisition module 108 is implemented by the control unit 11.

### 6-1. Modification Example 1

For example, the registered information acquisition module 102 may acquire only one piece of registered information, but in Modification Example 1, a case in which the registered information acquisition module 102 acquires a plurality of pieces of registered information is taken as an example. A search engine which searches registered information may calculate relevance information relating to a relevance of each of the plurality of pieces of registered information with the posted information. The registered information acquisition module 102 in Modification Example 1 acquires the plurality of pieces of registered information associated with the relevance information relating to the relevance with the posted information.

As used herein, “relevance” refers to the degree to which the piece of registered information matches the posted information. For example, the relevance information is a ranking corresponding to the level of relevance with the posted information, or a score indicating the level of relevance with the posted information. The score may be a publicly-known score such as a term frequency-inverse document frequency (TF-IDF). The method of calculating the relevance information may be the same as that used by a publicly-known search engine. For example, the relevance information is expressed as a numerical value, a character, a symbol, or a combination of those.

The work support module 103 in Modification Example 1 performs the work support by the AI based on the relevance information of each of the plurality of pieces of registered information. For example, the work support module 103 inputs each of the plurality of pieces of registered information and the relevance information associated with each of the plurality of pieces of registered information to the AI. The AI calculates an embedded representation based on those pieces of information, and outputs generated information corresponding to the embedded representation. The work support module 103 may input, among the plurality of pieces of registered information, only the pieces of registered information having a relatively high relevance indicated by the relevance information to the AI. As used herein, “relatively high relevance” means having a ranking that is a predetermined position or higher, having a score in the top “m” positions (“m” is any natural number that serves as a threshold value), or having a score that is equal to or higher than a threshold value.

For example, the search engine may calculate the relevance information based on an algorithm used in general-purpose searches instead of an algorithm specific to the work support system 1. In this case, the relevance information calculated by the search engine may not be relevance information specific to the work support system 1. Thus, in Modification Example 1, a case in which the relevance information calculated by the search engine is changed by meta information, which is information specific to the work support system 1, is taken as an example.

The work support system 1 according to Modification Example 1 includes the meta information acquisition module 104. The meta information acquisition module 104 acquires meta information associated with each of the plurality of pieces of registered information. The meta information is attendant information associated with each of the plurality of pieces of registered information. The meta information can also be said to be an attribute of the registered information. For example, when the registered information is other posted information (for example, posted information of a post input by another user) different from the posted information acquired by the posted information acquisition module 101, the meta information may be the number of likes, the number of views, the number of replies, the posting user ID, the post time, or other information on the other posted information. The meta information may be information indicating the importance of the registered information. For example, registered information having a large number of likes, views, or replies is attracting attention from more users, and is therefore information having a high level of importance. Registered information posted by a user having a specific posting user ID, such as an executive of an organization, is information having a high level of importance.

The meta information may be any information that corresponds to the registered information. The meta information is not limited to the above-mentioned information such as the number of likes. For example, when the registered information is a document such as an employee directory, a catalog, or an inquiry example, the meta information may be the update date and time of the document or the version of the document. Those pieces of meta information are assumed to be stored in the registered information database DB2. The meta information acquisition module 104 acquires the meta information associated with each of the plurality of pieces of registered information acquired by the registered information acquisition module 102 from the registered information database DB2. The meta information may be stored in another database different from the registered information database DB2. In that case, the meta information acquisition module 104 may acquire the meta information associated with each of the plurality of pieces of registered information acquired by the registered information acquisition module 102 from the another database.

The work support module 103 in Modification Example 1 changes the relevance information of each of the plurality of pieces of registered information based on the meta information of each of the plurality of pieces of registered information, and performs input to the AI based on the changed relevance information of each of the plurality of pieces of registered information. For example, the work support module 103 changes the relevance information based on the meta information of each of the plurality of pieces of registered information such that the relevance indicated by the relevance information of the pieces of registered information that have a relatively high importance in the work support system 1 is increased. The importance is estimated based on the content of the meta information. For example, a large number of likes, views, replies, or other numerical value corresponds to a high importance. For example, the posting user ID being a specific user ID (for example, the user ID of an executive of an organization) corresponds to a high importance.

For example, there may be a case in which each of the plurality of pieces of registered information is other posted information different from the posted information acquired by the posted information acquisition module 101. In this case, as an example, when the number of likes corresponds to the meta information, the work support module 103 changes the relevance information of each of the plurality of pieces of registered information in accordance with the number of likes indicated by the meta information of the registered information. The work support module 103 changes the relevance information such that the relevance indicated by the relevance information of the pieces of registered information having a relatively large number of likes becomes higher.

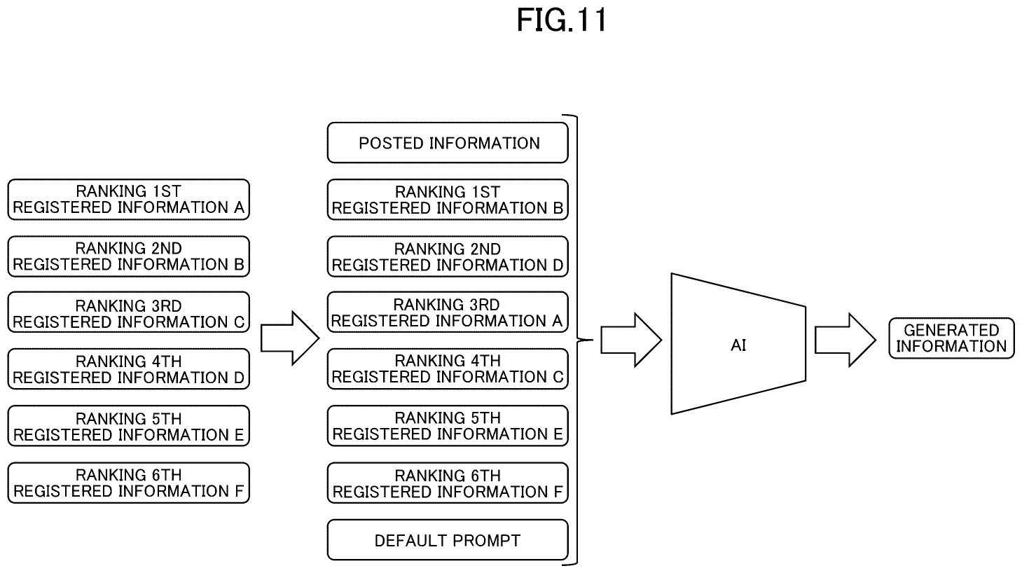

FIG. 11 is a diagram for illustrating an example of relevance information changed in Modification Example 1. For example, when the relevance information indicates a ranking, the work support module 103 switches the rankings based on the number of likes for each of the plurality of pieces of registered information. That is, the work support module 103 re-ranks each of the plurality of pieces of registered information based on the number of likes for each of the plurality of pieces of registered information. The work support module 103 may execute the re-ranking simply in order of the number of likes, or may change the ranking of only the pieces of registered information having the number of likes equal to or more than a threshold value so that those pieces of registered information have a higher ranking than the current ranking. As another example, the work support module 103 may change the ranking of only pieces of registered information having the number of likes less than a threshold value so that those pieces of registered information have a lower ranking than the current ranking.

In the example of FIG. 11, the registered information acquisition module 102 acquires registered information A associated with the piece of relevance information indicating a ranking of 1st, registered information B associated with the piece of relevance information indicating a ranking of 2nd, registered information C associated with the piece of relevance information indicating a ranking of 3rd, registered information D associated with the piece of relevance information indicating a ranking of 4th, registered information E associated with the piece of relevance information indicating a ranking of 5th, and registered information F associated with the piece of relevance information indicating a ranking of 6th. Those rankings are calculated by a search engine.

For example, the meta information acquisition module 104 acquires the number of likes for each of the pieces of registered information A to F as meta information. When the number of likes for the pieces of registered information B and D is more than the number of likes for the pieces of registered information A, C, E, and F, the work support module 103 changes the rankings of the pieces of registered information B and D, which have a relatively large number of likes, so that the pieces of registered information B and D are ranked higher than the ranking calculated by the search engine. In other words, the work support module 103 changes the rankings of the pieces of registered information A, C, E, and F, which have a relatively smaller number of likes, so that the pieces of registered information A, C, E, and F are ranked lower than the ranking calculated by the search engine.

For example, the work support module 103 inputs the posted information, the pieces of registered information A to F, the ranking of each of the pieces of registered information A to F after the change, and a default prompt to the AI, and presents the generated information output from the AI to the user, to thereby perform work support to the user. As the default prompt, a prompt to generate the generated information based on ranking may be used, such as “Generate generated information taking into consideration the ranking of each of the plurality of pieces of registered information.” The work support module 103 may input only the pieces of registered information that have a relatively high ranking after the change among the pieces of registered information A to F (for example, only the top three pieces of registered information B, D, and A) to the AI.

In addition, the work support module 103 may determine a final ranking based only on the number of likes for each of the pieces of registered information A to F. In this case, however, the final ranking is determined in descending order of the number of likes, and the calculation results of the search engine are not reflected. For this reason, the work support module 103 may determine the final ranking by comprehensively taking into account the rankings calculated by the search engine and the number of likes for each of the pieces of registered information A to F. For example, the work support module 103 may determine the final ranking such that fluctuation in the rankings based on the number of likes falls within a predetermined order (for example, such that the ranking calculated by the search engine does not rise by three places or more no matter how many likes there are).

For example, when the relevance information indicates a score, the work support module 103 changes the score based on the number of likes for each of the plurality of pieces of registered information. The work support module 103 may increase or decrease the score in accordance with the number of likes, or may change the score of only the pieces of registered information having the number of likes equal to or more than a threshold value such that those pieces of registered information have a higher score than the current score. As another example, the work support module 103 may change the score of only the pieces of registered information having the number of likes less than a threshold value such that those pieces of registered information have a lower score than the current score. The work support module 103 may perform input to the AI based on the changed relevance information. For example, the work support module 103 may input the changed relevance information to the AI, or may input only the pieces of registered information having a relevance indicated by the changed relevance information that is relatively high to the AI.

Even when the meta information is information other than the number of likes, the work support module 103 may change the relevance information of each of the plurality of pieces of registered information based on the meta information of each of the plurality of pieces of registered information. For example, when the meta information is the number of views or the number of replies, the work support module 103 may change the relevance information such that the ranking of pieces of registered information having a relatively large number of views or replies is higher than the current ranking, or the score of those pieces of registered information is higher than the current score. When the meta information is the posting user ID, the work support module 103 may change the relevance information such that the ranking of a piece of registered information having a specific posting user ID is higher than the current ranking, or the score of the piece of registered information is higher than the current score.

The work support system 1 according to Modification Example 1 acquires a plurality of pieces of registered information associated with relevance information relating to a relevance with the posted information. The work support system 1 acquires meta information associated with each of the plurality of pieces of registered information. The work support system 1 changes the relevance information of each of the plurality of pieces of registered information based on the meta information of each of the plurality of pieces of registered information, and performs input to the AI based on the changed relevance information of each of the plurality of pieces of registered information. As a result, the work support system 1 can perform input to the AI based on relevance information suitable for the work support system 1, thereby increasing the accuracy of work support.

### 6-2. Modification Example 2

For example, as described in the at least one embodiment, the work support module 103 may input registered information to the AI. In this case, the AI may calculate a score regarding the plausibility of the generated information. The score indicates the accuracy of the generated information. The score may also be referred to as likelihood, confidence, or probability. The method of calculating the score may be the same as a publicly-known method. For example, the AI may calculate the score of the generated information based on a publicly-known calculation method such as an n-gram model, a hidden Markov model, a transformer model, or a probabilistic language model. The score is expressed as a numerical value, a character, a symbol, or a combination of those. In Modification Example 2, the score is a numerical value. When the numerical value is higher, the generated information is more plausible. The score in Modification Example 2 is calculated by the AI, and hence the score is different from the score, which is the example of relevance information in Modification Example 1.

The work support module 103 in Modification Example 2 acquires generated information generated by the AI and a score relating to the plausibility of the generated information. The work support module 103 performs work support to the user by presenting the generated information to the user based on the score. For example, the work support module 103 determines whether the score is equal to or more than a threshold value. When it is determined that the score is less than the threshold value, the work support module 103 does not present the generated information to the user (does not perform work support to the user), and when the score is determined to be equal to or more than the threshold value, the work support module 103 presents the generated information to the user (performs work support to the user).

The work support system 1 according to Modification Example 2 inputs registered information to the AI, and acquires generated information generated by the AI and a score relating to the plausibility of the generated information. The work support system 1 performs work support to the user by presenting the generated information to the user based on the score. As a result, the work support system 1 can perform suitable work support corresponding to the score of the generated information. For example, the work support system 1 can prevent generated information having a low score from being presented to the user. The work support system 1 can present generated information having a higher accuracy to the user by presenting generated information having a high score to the user. From the perspective of the user, it may be bothersome to be presented with low-accuracy generated information each time a user posts something, but the work support system 1 prevents the user from being bothered and can perform more suitable work support.

### 6-3. Modification Example 3

For example, the work support system 1 may receive feedback from the user regarding the work support by the AI. The feedback may be provided through a selection indicating that the generated information is good, a selection indicating that the generated information is not good, input of a numerical score indicating an evaluation of the generated information generated by the AI, input of a character string in natural language indicating specific content of feedback from the user, or another operation. As another example, when the generated information presented to the user includes a link, whether or not the user has selected the link may correspond to the feedback. When a new post of the user after the generated information is presented includes content relating to the generated information, the user may have referred to the generated information, and hence the new post may correspond to the feedback. In Modification Example 3, a case in which feedback from the user is learned by the AI is taken as an example.

The work support system 1 according to Modification Example 3 includes the feedback acquisition module 105 and the learning module 106. The feedback acquisition module 105 acquires feedback from the user regarding the work support performed by the AI. For example, when an icon for providing feedback is displayed near the generated information from the AI displayed on the app screen SC, the feedback acquisition module 105 acquires feedback from the user based on an operation on the icon. When an icon indicating that the generated information is good is selected, the feedback acquisition module 105 acquires feedback indicating that the generated information is good. When an icon indicating that the generated information is not good is selected, the feedback acquisition module 105 acquires feedback indicating that the generated information is not good.

For example, when a user interface part for receiving input of a numerical score for providing feedback is displayed near the generated information from the AI displayed on the app screen SC, the feedback acquisition module 105 acquires the numerical score input by the user as feedback based on an operation on the part. When an input form for receiving input of a character string in natural language for feedback is displayed near the generated information from the AI displayed on the app screen SC, the feedback acquisition module 105 acquires the character string input into the input form as feedback.

The learning module 106 causes the AI to learn the feedback. The learning method for causing the AI to learn the feedback from the user may be similar to a publicly-known learning method. For example, the learning module 106 may cause the AI to learn the feedback by causing the AI to learn the feedback from the user as a reward in reinforcement learning. In this case, the learning module 106 causes the AI to learn the feedback by fine-tuning the parameters of the AI based on the feedback from the user and a reinforcement learning algorithm.

For example, the learning module 106 may cause the AI to learn the feedback by treating the user's feedback as training data based on a learning method called supervised learning. As described in the at least one embodiment, when the AI is managed by an external system, the learning module 106 may cause the AI to learn the feedback by transmitting the feedback from the user to the external system. In this case, the processing of adjusting the parameters of the AI is executed by the external system. When the AI is managed by the work support system 1, the learning module 106 itself may adjust the parameters of the AI based on the feedback.

The work support system 1 according to Modification Example 3 acquires feedback from the user regarding the work support by the AI. The work support system 1 causes the AI to learn the feedback. As a result, the work support system 1 can increase the accuracy of the AI through the feedback from the user. The work support system 1 can perform highly accurate work support, and hence can effectively increase the convenience of the user.

### 6-4. Modification Example 4

For example, the information which the work support module 103 refers to in order to perform the work support by the AI is not limited to the posted information and the registered information described in the at least one embodiment. In Modification Example 4, a case in which attribute information on the user is referred to is taken as an example. The attribute information is information relating to an attribute of the user. The attribute can also be said to be a classification of the user. For example, the attribute information may be the organization, industry, department, job title, team, role, years of service, or other profile of the user. The attribute information may be demographic information, such as the gender or age of the user.

The work support system 1 according to Modification Example 4 includes the attribute information acquisition module 107. The attribute information acquisition module 107 acquires attribute information relating to the user. The data storage unit 100 in Modification Example 4 stores a user database in which various types of information on the user is stored. For example, the user ID and the attribute information are associated with each other in the user database. The attribute information acquisition module 107 acquires the attribute information on the user from the user database. In the example of the app screens SC of FIG. 2 to FIG. 4, when a user inputs a post in the input form F, the attribute information acquisition module 107 acquires attribute information associated with the user ID of the user.

The method of identifying the user ID may be the same as that adopted in a publicly-known online service. For example, the attribute information acquisition module 107 may identify which user is accessing the work support system 1 based on a session ID that can identify the session of the server 10 and the user terminal 20, and acquire the attribute information associated with the user ID of the user. The user attribute information may be stored in a database other than the user database, a computer other than the server 10, or an information storage medium. In this case, the attribute information acquisition module 107 may acquire the attribute information from the other database, the other computer, or the information storage medium.

The work support module 103 in Modification Example 4 performs the work support by the AI further based on attribute information. For example, the work support module 103 inputs not only the posted information, the registered information, and a default prompt, but also the attribute information to the AI. The default prompt may include description of an instruction in natural language to generate generated information corresponding to the attribute information, such as “Generate generated information corresponding to the attribute information on the user.” The AI calculates an embedded representation based on not only the posted information, the registered information, and the default prompt, but also the attribute information, and outputs generated information corresponding to the embedded representation. The work support module 103 acquires the generated information output from the AI, and presents the generated information to the user, to thereby perform the work support by the AI.

For example, there may be a case in which the attribute information is the job title of the user, and the default prompt indicates an instruction such as “Generate generated information corresponding to the job title of the user.” In this case, the AI outputs generated information corresponding to the job title of the user. For example, when the user is an executive, the user may be very familiar with information about the overall organization, but may not have an understanding of the detailed specifications of each individual product. For this reason, there is a possibility that the generated information generated by the AI includes detailed specifications of the target product, instead of information about the overall organization. When the user is a new employee, the user may not have an understanding of information about the overall organization and may also not have an understanding of the detailed specifications of each individual product. For this reason, there is a possibility that the generated information generated by the AI includes an overview of both.

The work support system 1 according to Modification Example 4 acquires attribute information on the user. The work support system 1 performs the work support by the AI further based on the attribute information. As a result, the work support system 1 can perform work support corresponding to the attribute information on the user, thereby further increasing the convenience of the user. For example, the AI may vary the content of the generated information in accordance with the attribute information, such as the job title of the user, and hence the work support system 1 can present generated information suitable for the user.

### 6-5. Modification Example 5

For example, the content of the suitable work support may change depending on the place in which the user has made the post. As used herein, “place” does not refer to a place in the real world where the user is, but to the place on the work support system 1 in which the user has uploaded the posted information. For example, the app in which the user has made the post, the thread in which the user has made the post, the schedule in which the user has made the post, or the email in which the user has made the post corresponds to the “place in which the user has made the post.” In Modification Example 5, a case in which work support corresponding to the place in which the user has made the post is performed is taken as an example.

The work support system 1 according to Modification Example 5 includes the place information acquisition module 108. The place information acquisition module acquires place information relating to the place in which a post has been made in the work support system 1. In Modification Example 5, a case in which the place information is stored in the posted information database DB1 is taken as an example. For this reason, the place information acquisition module 108 acquires the place information from the posted information database DB1. The place information may be stored in a database other than the posted information database DB1, in a computer other than the server 10, or in an information storage medium. In this case, the place information acquisition module 108 may acquire the place information from the another database, the another computer, or the information storage medium.

The work support module 103 in Modification Example 5 performs the work support by the AI further based on the place information. For example, the work support module 103 inputs not only the posted information, the registered information, and a default prompt, but also the place information to the AI. The default prompt may include description of an instruction in natural language to generate generated information corresponding to the place information, such as “Generate generated information corresponding to the place information on the user.” The AI calculates an embedded representation based on not only the posted information, the registered information, and the default prompt, but also the place information, and outputs generated information corresponding to the embedded representation. The work support module 103 acquires the generated information output from the AI, and presents the generated information to the user, to thereby perform the work support by the AI.

For example, there may be a case in which the place information indicates the app in which the user has made the post, and the default prompt indicates an instruction such as “Generate generated information corresponding to the app in which the user has made the post.” In this case, the AI outputs generated information corresponding to the app in which the user has made the post. For example, when the user has made a post to a customer management app, generated information including content relating to customers may be suitable. In that case, the AI may generate generated information that includes content relating to customers. When the user has made a post to an expense reimbursement app, generated information that includes content relating to expense reimbursement may be suitable. In that case, the AI may generate generated information that includes content relating to expense reimbursement.

The work support system 1 according to Modification Example 5 acquires place information relating to the place in which the post is made in the work support system 1. The work support system 1 performs the work support by the AI further based on the place information. As a result, the work support system 1 can perform work support corresponding to the place in which the user has made the post, thereby further increasing the convenience of the user. For example, the AI may vary the content of the generated information in accordance with the place in which the user has made the post, and hence the work support system 1 can present generated information suitable for the user.

### 6-6. Modification Example 6

For example, in Modification Example 1, a case in which meta information is used to change the relevance information is taken as an example. However, the meta information may be used for a purpose other than changing the relevance information. In Modification Example 6, an example in which the meta information is used for another purpose is described. The work support system 1 according to Modification Example 6 includes the meta information acquisition module 104. The meta information acquisition module 104 is as described in Modification Example 1. In Modification Example 6, the meta information acquisition module 104 may be a function included in the registered information acquisition module 102.

The registered information acquisition module 102 in Modification Example 6 acquires registered information based on meta information. For example, the registered information acquisition module 102 may acquire registered information based on not only vector information but also meta information. When the meta information is the number of likes, the registered information acquisition module 102 preferentially acquires registered information for which the meta information indicates a relatively large number of likes. The registered information acquisition module 102 may calculate a suitability score indicating the suitability of the registered information based on the vector information and the meta information, and acquire the registered information based on the suitability score.

For example, an expression for calculating the suitability score may be determined such that the suitability score becomes higher when the distance in the vector space described in the at least one embodiment is shorter and the number of likes is larger. The expression for calculating the suitability score is stored in the data storage unit 100. The suitability score can be calculated in the same manner even when the number of views or the number of replies is used as the meta information instead of the number of likes. The registered information acquisition module 102 acquires registered information having a relatively high suitability score. For example, the registered information acquisition module 102 may acquire the registered information having the highest suitability score. The registered information acquisition module 102 may acquire a predetermined number of pieces of registered information having a higher suitability score (for example, the top five pieces of registered information). The registered information acquisition module 102 may acquire registered information having a suitability score equal to or higher than a threshold value.

For example, when the meta information is the posting user ID, the registered information acquisition module 102 preferentially acquires registered information in which the posting user ID indicated by the meta information is a specific user ID (for example, the user ID of an executive). The expression for calculating the suitability score may be determined such that the suitability score is higher when the distance in the vector space described in the at least one embodiment is shorter and the meta information indicates a specific user ID. The registered information acquisition module 102 acquires registered information having a relatively high suitability score. The flow of the work support after the registered information acquisition module 102 acquires the registered information may be the same as that of the at least one embodiment or Modification Examples 1 to 5.

The work support system 1 according to Modification Example 6 acquires meta information associated with registered information. The work support system 1 acquires the registered information further based on the meta information. As a result, the work support system 1 can perform work support based on the registered information corresponding to the meta information, and hence work support which is more appropriate can be performed. The work support system 1 can increase the convenience of the user. For example, the work support system 1 can perform work support based on highly important registered information that has a relatively large number of likes. The work support system 1 can perform work support based on the registered information posted by an executive of an organization.

### 6-7. Modification Example 7

For example, as described somewhat in the at least one embodiment, schedule information relating to a schedule of another user different from the user may be stored as registered information in the registered information database DB2. The schedule information is information indicating details of the schedule. For example, the schedule information may indicate a date and time, a title, a place, a participant, a note to remember, a reserved facility, or another piece of information of the schedule. The schedule information may be similar to information used in a publicly-known schedule management tool. In Modification Example 7, it is assumed that information that can identify which schedule information belongs to which user is stored in the registered information database DB2.

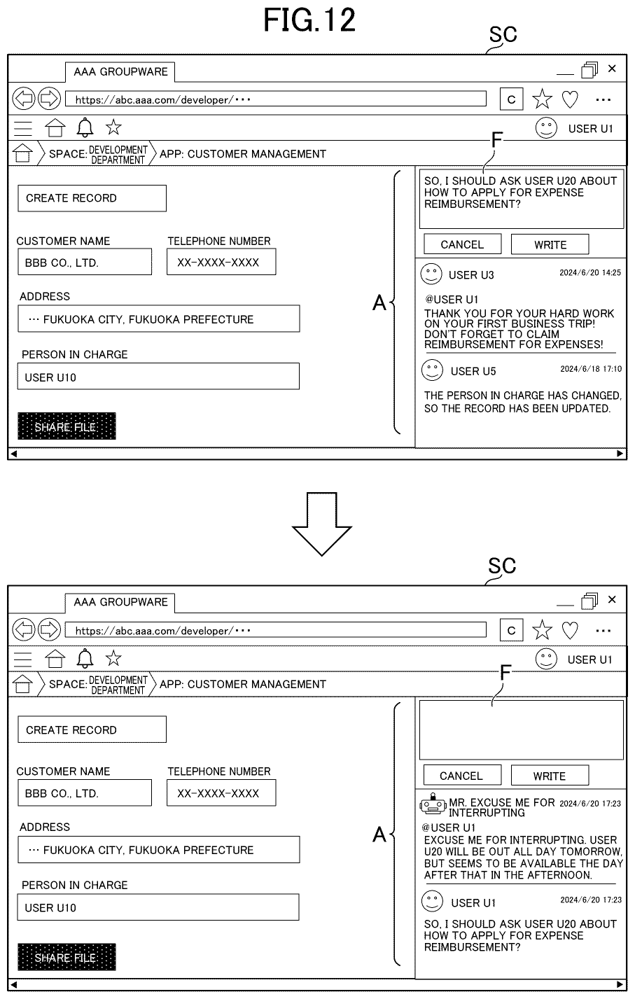

FIG. 12 is a view for illustrating an example of an app screen SC in Modification Example 7. The registered information acquisition module 102 in Modification Example 7 acquires schedule information as registered information. For example, the registered information acquisition module 102 identifies another user designated by the user based on the posted information of the user. In the example of the upper part of FIG. 12, the name of another user (for example, “user U20”) is contained in the character string included in the post of the user. The data storage unit 100 in Modification Example 7 stores a user database in which information on, for example, the names of various users who use the work support system 1 is stored. The registered information acquisition module 102 identifies the name of the another user contained in the post by comparing the character string indicated by the posted information with the names stored in the user database. The registered information acquisition module 102 acquires the schedule information of the identified another user from the registered information database DB2. The another user may be identified by using other information, such as a user ID, instead of a name.

The work support module 103 in Modification Example 7 performs the work support by the AI based on schedule information. In Modification Example 7, a case in which the AI is not so-called generative AI, such as a large language model, but is a program which supports the work of the user by using information processing is taken as an example. The actual data of the AI is stored in the data storage unit 100. For example, the work support module 103 performs work support by displaying the content of the schedule information acquired by the registered information acquisition module 102 on the app screen SC based on processing executed by a program equivalent to AI. In the example of the lower part of FIG. 12, the work support module 103 displays the content of the schedule information (for example, the dates and times when the another user indicated by the posted information has a scheduled appointment) on the app screen SC as a post indicating an answer from the AI. The work support module 103 may display the available times of the another user identified based on the schedule information on the app screen SC as a post indicating an answer from the AI.

In addition, in Modification Example 7 as well, the AI may be so-called generative AI. In this case, the work support module 103 inputs not only the posted information, the registered information, and a default prompt, but also the schedule information to the AI. The default prompt include description of an instruction in natural language to generate generated information corresponding to the schedule information, such as “Generate generated information corresponding to the schedule information on the user.” The AI calculates an embedded representation based on not only the posted information, the registered information, and the default prompt, but also the schedule information, and outputs generated information corresponding to the embedded representation. The work support module 103 may perform the work support by the AI by acquiring the generated information output from the AI, and presenting the generated information to the user.

In the registered information database DB2 in Modification Example 7, schedule information relating to a schedule of another user different from the user is stored as registered information. The work support system 1 acquires the schedule information as registered information. The work support system 1 performs the work support by the AI based on the schedule information. As a result, the work support system 1 can perform work support corresponding to the schedule information, thereby further increasing the convenience of the user.

### 6-8. Modification Example 8

For example, in Modification Example 7, the user may make a post which mentions another user. A mention is a designation of another user to whom the user wants to notify about the post. For example, the user can mention another user by inputting a specific symbol (for example, @) followed by information on the another user (for example, the name of the another user). The mention is displayed on the screen of the another user. The mention mechanism may be similar to a publicly-known mechanism. For example, an email may be sent to the mentioned another user indicating that he or she has been mentioned.

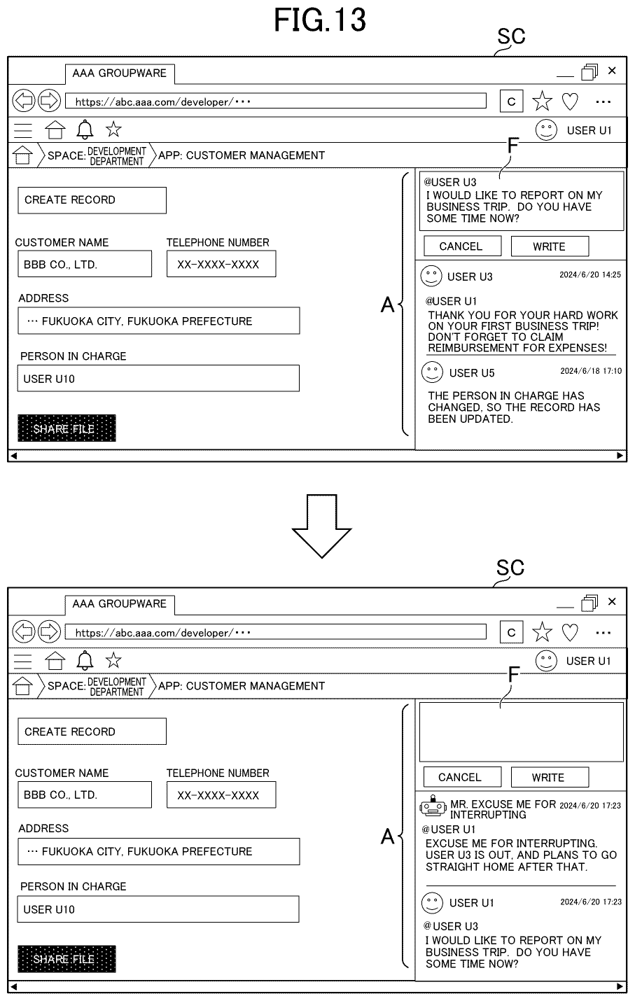

FIG. 13 is a view for illustrating an example of an app screen SC in Modification Example 8. As illustrated in the upper part of FIG. 13, the posted information acquisition module 101 acquires posted information in which another user is mentioned. In the example of the upper part of FIG. 13, the user mentions another user by inputting a specific symbol (for example, @) followed by the name of the another user (for example, the character string “user U3”). The posted information includes the specific symbol followed by the name of the another user. The another user can know that he or she has been mentioned by, for example, a notification function on the work support system 1 or by email.

The registered information acquisition module 102 in Modification Example 8 acquires the schedule information of the another user mentioned in the posted information as registered information. For example, the registered information acquisition module 102 identifies the name of the another user input after the specific symbol in the posted information. The registered i n acquisition module 102 acquires the schedule information of the identified another user from the registered information database DB2. When a plurality of other users are mentioned in a single piece of posted information, the registered information acquisition module 102 acquires the schedule information of each of the plurality of other users.

The work support module 103 in Modification Example 8 performs the work support by the AI based on the schedule information of the another user mentioned in the posted information. In Modification Example 8, as in Modification Example 7, the AI is not so-called generating AI, but a program which supports the work of the user by using information processing. For example, the work support module 103 performs work support by displaying the content of the schedule information acquired by the registered information acquisition module 102 on the app screen SC based on processing executed by a program equivalent to the AI. In the example of the lower part of FIG. 13, the work support module 103 displays the content of the schedule information (for example, the dates and times when the another user mentioned in the posted information has a scheduled appointment) on the app screen SC as a post indicating an answer from the AI. The work support module 103 may display the available times of the another user identified based on the schedule information on the app screen SC as a post indicating an answer from the AI. In addition, as in Modification Example 7, the AI may be so-called generative AI in Modification Example 8 as well.

The work support system 1 according to Modification Example 8 acquires posted information in which another user is mentioned. The work support system 1 acquires schedule information of the another user mentioned in the posted information as registered information. The work support system 1 performs the work support by the AI based on the schedule information of the another user mentioned in the posted information. As a result, the work support system 1 can perform work support corresponding to the schedule information of the mentioned another user, thereby further increasing the convenience of the user. For example, the user can easily know the schedule of the person who the user has mentioned without displaying a schedule screen of that person. For example, the user can easily know whether or not the person who the user has mentioned is in a situation in which he or she can reply immediately.

### 6-9. Modification Example 9

For example, the user can input posted information in any language. The registered information may be in the same language as the language of the posted information, or in a language different from the language of the posted information. In Modification Example 9, a case in which the registered information acquisition module 102 acquires registered information written in another language different from the language of the posted information is taken as an example. The vector information stored in the registered information database DB2 may be common regardless of language, or vector information may be prepared for each language. The language of the posted information may be specified by any method, for example, the user himself or herself may specify the language, or the language of the posted information may be specified by natural language processing.

The work support module 103 in Modification Example 9 performs the work support by the AI based on registered information written in a language different from the language of the posted information. For example, the work support module 103 inputs posted information written in a first language and registered information written in a second language different from the first language to the AI. Users often want to view generated information in the same first language as the language of the post of the user, and hence a default prompt in which an instruction such as “Generate generated information in the same first language as that of the posted information of the user” is written in a natural language may be input to the AI.

For example, the AI calculates an embedded representation based on the posted information in a first language, the registered information in a second language, and a default prompt, and outputs generated information corresponding to the embedded representation. The work support module 103 may perform the work support by the AI by acquiring the generated information output from the AI and presenting the generated information to the user. The work support module 103 may machine-translate the posted information in a first language into the second language, and input the translation to the AI. The work support module 103 may machine-translate the registered information in the second language into the first language, and input the translation to the AI.

The work support system 1 according to Modification Example 9 acquires registered information written in another language different from the language of the posted information. The work support system 1 performs the work support by the AI based on the registered information written in the different language. As a result, the work support system 1 can perform work support in various languages, thereby increasing the convenience of the user.

### 6-10. Other Modification Examples

For example, two or more of Modification Examples 1 to 9 may be combined.

For example, the functions described as being implemented by the server 10 may be implemented by the user terminal 20. In this case, it suffices that the functions are implemented by a browser script or an application installed on the user terminal 20. For example, the respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, comprising at least one processor configured to:
acquire posted information relating to a post input by a user to a work support system that supports work of the user;
acquire, based on the posted information, registered information registered in the work support system; and
perform work support by an artificial intelligence (AI) based on the registered information.

2. The work support system according to claim 1, wherein the at least one processor is configured to perform the work support to the user by inputting the posted information and the registered information to the AI and presenting generated information generated by the AI to the user.

3. The work support system according to claim 2, wherein the at least one processor is configured to:
acquire a plurality of pieces of the registered information associated with relevance information relating to relevance with the posted information;
acquire meta information associated with each of the plurality of pieces of the registered information; and
change the relevance information of each of the plurality of pieces of the registered information based on the meta information of each of the plurality of pieces of the registered information, and perform input to the AI based on the changed relevance information of each of the plurality of pieces of the registered information.

4. The work support system according to claim 1, wherein the at least one processor is configured to:
input the registered information to the AI;
acquire generated information generated by the AI and a score relating to a plausibility of the generated information; and
perform the work support to the user by presenting the generated information to the user based on the score.

5. The work support system according to claim 1, wherein the at least one processor is configured to:
acquire feedback from the user regarding the work support by the AI; and
cause the AI to learn the feedback.

6. The work support system according to claim 1, wherein the at least one processor is configured to:
acquire attribute information relating to the user; and
perform the work support by the AI further based on the attribute information.

7. The work support system according to claim 1, wherein the at least one processor is configured to:
acquire place information relating to a place in which the post is made in the work support system; and
perform the work support by the AI further based on the place information.

8. The work support system according to claim 1, wherein the at least one processor is configured to:
acquire meta information associated with the registered information; and
acquire the registered information based on the meta information.

9. The work support system according to claim 1, wherein the at least one processor is configured to:
acquire schedule information relating to a schedule of another user different from the user as the registered information; and
perform the work support by the AI based on the schedule information.

10. The work support system according to claim 9, wherein the at least one processor is configured to:
acquire the posted information in which the another user is mentioned;
acquire, as the registered information, the schedule information of the another user mentioned in the posted information; and
perform the work support by the AI based on the schedule information of the another user mentioned in the posted information.

11. The work support system according to claim 1, wherein the at least one processor is configured to:
acquire the registered information which is written in another language different from a language of the posted information; and
perform the work support by the AI based on the registered information written in the different language.

12. A work support method, comprising:
acquiring posted information relating to a post input by a user to a work support system that supports work of the user;
acquiring, based on the posted information, registered information registered in the work support system; and
performing work support by an artificial intelligence (AI) based on the registered information.

13. A non-transitory information storage medium having stored thereon a program for causing a computer to:
acquire posted information relating to a post input by a user to a work support system that supports work of the user;
acquire, based on the posted information, registered information registered in the work support system; and
perform work support by an artificial intelligence (AI) based on the registered information.
